(19) United States
(12) Patent Application Publication
(10) Pub. No.: US 2008/0288229 A1
(43) Pub. Date: Nov. 20, 2008

(54) Apparatus and Method for Creating Solid Models for Clinical Diagnosis

(76) Inventor: Aldo Arvizo Arvizo, Chihuahua (MX)

Correspondence Address: PEACOCK MYERS, P.C., 201 THIRD STREET, N.W., SUITE 1340, ALBUQUERQUE, NM, 87102, US

(21) Appl. No.: 12/125,608

(22) Filed: May 22, 2008

Related U.S. Application Data
(63) Continuation of application No. PCT/MX2006/000102, filed on Sep. 27, 2006.

(51) Int. Cl. G06G 7/60

(52) U.S. Cl. 703/11

(57) ABSTRACT

Solid models for clinical diagnosis, which models are a physical representation, in terms of size and volume, of a tissue of a living patient chosen for a clinical study. These solid models for clinical diagnosis can be used to obtain information regarding actual dimensions of the tissue morphological characters and they can be handled to dissect, prognosticate and evaluate progressive injuries and to plan and choose materials to be used right away or during surgical treatment.

### CROSS-REFERENCE TO RELATED APPLICATIONS

This application is a continuation of Patent Cooperation Treaty Application Serial No. PCT/MX2006/000102 entitled “Solid Models for Medical Diagnosis” having an international filing date of Sep. 27, 2006, and the specification and claims are incorporated herein by reference.

### BACKGROUND OF THE INVENTION

1. Field of the Invention (Technical Field)

Embodiments of the present invention relate to a clinical diagnosis system which size and volume represent a tissue previously chosen for a clinical study. The system is capable to provide internal observation to measure, dissect and diagnose, evaluate lesions, progressive injuries and prognosticate and plan, over the very same model, a surgical intervention or a clinical treatment.

2. Background

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Nowadays, different medical diagnosis equipment is used to get information from tissue images through x-rays, topographies and magnetic resonance in order to diagnose leisure and injuries. An inconvenient of such images is that they will only provide a view to get an approximate measure of the tissues in 2 dimensional monochromatic images.

With the purpose of eliminating such inconveniences and to more efficiently use the information obtained from this equipment and advanced engineering techniques, a new clinical diagnosis solid-model system was developed. This system, which is to be protected by the request herein, consists of three dimensional solid models for clinical diagnosis that represent, in size and volume, a chosen tissue for clinical study. The analyst can evaluate diseases and their morphological dimensions and position as a whole over the model being able to dissect, prognosticate and evaluate progressive injuries and plan and choose proper materials to be used at the time of the clinical study or during surgery treatment.

### BRIEF SUMMARY OF THE INVENTION

The preferred invention relates to an apparatus and method for creating a solid model for clinical diagnosis comprising a tissue scanner that creates digital information, a processor that processes the digital information, a computer that generates a virtual model from the digital information, and a modeler that creates a three-dimensional solid model created from the virtual model. The computer comprises a tomographic computer and the processor comprises a digital processor. The solid model comprises a physical representation of the size, shape and volume of a tissue, as well as information to assess illnesses and diseases that affect the morphology and performance of a tissue.

The preferred invention relates to a method for creating solid models for clinical diagnosis comprising the steps of distinguishing the internal morphological character of tissues in a living patient by totally isolating it from other tissues for clinical studies, digitally processing a chosen tissue for clinical assessment by applying advanced engineering techniques, computing tomography from information obtained from digital processing, keeping actual existing separation distances between the tissues, and physically showing the actual size and shape of tissues. The preferred invention further relates to a method of accurately distinguishing the internal morphological character of the bones in a living patient.

The preferred invention relates to a method for characterizing solid models for clinical diagnosis comprising the steps of developing pre-surgery treatments on a non-sterilized field over the solid model with no need of the patient's presence, measuring accurate and actual dimensions, evaluating tool needs and special implant designs, and preparing systems related to the actual surgery. The accurate and actual dimensions are used on the solid model to choose the appropriate materials required at any time, including during surgical treatment.

The preferred invention further relates to a method for planning treatments and surgical operations that provide new surgical techniques for treating, prognosticating, and evaluating progressive injuries on tissues. The pre-surgery treatments on a non-sterilized field comprise providing useful information regarding internal characteristics by cutting and dissecting the solid model.

The preferred invention further relates to a method comprising saving the solid models indefinitely so the specialist can compare pre- and post-surgical evolutions. Developing pre-surgery treatments on a non-sterilized field comprise providing the tool to carry out a physical internal view scan of a tissue. The pre-surgery treatments comprise analyzing actual necessities, accurately performing surgery, prioritizing all technical steps, and greatly reducing surgery time. The pre-surgery treatments comprise a comparison tool to evaluate the quality of an actual surgery and the condition of a real tissue.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention.

The details of this new element are depicted in the following description along with pictures and illustrations, following the same reference points to show the parts and the depicted figures. In the drawings:

FIG. 1 is an illustration of a conventional thorax x-ray film.

FIG. 2 is an illustration of a conventional computed tomography on a thorax with various images showing transversal axial cuts.

FIG. 3 is an illustration of a front view of one of the solid models on the vertebral lumbar bodies of the spinal cord for three-dimensional clinical diagnosis, pointing out L2 (second lumbar) 1.

FIG. 4 is an illustration of a back view of the solid model in the vertebral bodies of the spinal cord.

FIG. 5 is an illustration of a vertebral body that was isolated from the vertebral bodies shown in FIGS. 3 and 4 of the model for clinical diagnosis, pointing out L2 (second lumbar) 1.

FIG. 6 is an illustration of a top view of the solid model of spinal cord showed in FIGS. 3 and 4.

FIG. 7 is an illustration of a conventional x-ray film of the hips.

FIG. 8 is an illustration of a computed tomography of the hips as well as its transversal axial cuts.

FIG. 9 is an illustration of a front view of the hips made out with the solid model for clinical diagnosis.

FIG. 10 is an illustration of a top view of the hips made out with the solid models for clinical diagnosis.

FIG. 11 is an illustration of a bottom view of the hips made out with solid models for clinical diagnosis.

FIG. 12 is an illustration of a conventional x-ray film of the left knee.

FIG. 13 is an illustration of a conventional tomography of the left knee and its axial cuts displayed on horizontal layouts.

FIG. 14 is an illustration of a clinical diagnosis solid model of a left knee.

FIG. 15 is an illustration of a view of the solid model for clinical diagnosis of a left knee by the back in a horizontal position.

FIG. 16 is an illustration of a bottom view of solid models for clinical diagnosis of the tibia and fibula.

FIG. 17 is an illustration of a top view of a solid model for clinical diagnosis of a femur.

FIG. 18 is an illustration of a bottom view of the solid models system for clinical diagnosis.

FIG. 19 is an illustration of a top cut view of the solid models for clinical diagnosis of the tibia and fibula.

FIG. 20 is an illustration of a front view of a simple and conventional x-ray film of the maxillaries.

FIG. 21 is an illustration of a horizontal axial cut view of a conventional tomography of the maxillaries.

FIG. 22 is an illustration of a solid model system for clinical diagnosis of the maxillary.

FIG. 23 is an illustration of a front view of a solid model for clinical diagnosis of a maxillary.

FIG. 24 is an illustration of a left side view of the solid model for clinical diagnosis of a maxillary section.

FIG. 25 is an illustration of a left side view of the solid model system for clinical diagnosis of the maxillary.

### DETAILED DESCRIPTION OF THE INVENTION

As used herein “a” means one or more.

The preferred embodiment of the invention comprises the following. As an integral part of the above-mentioned description, the following explanation is presented for a better understanding of the pictures shown with illustrative and unlimited purposes:

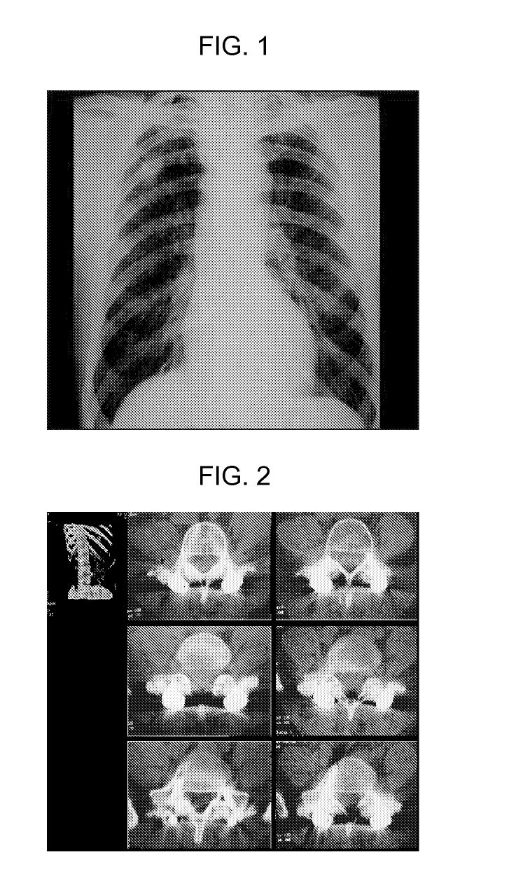

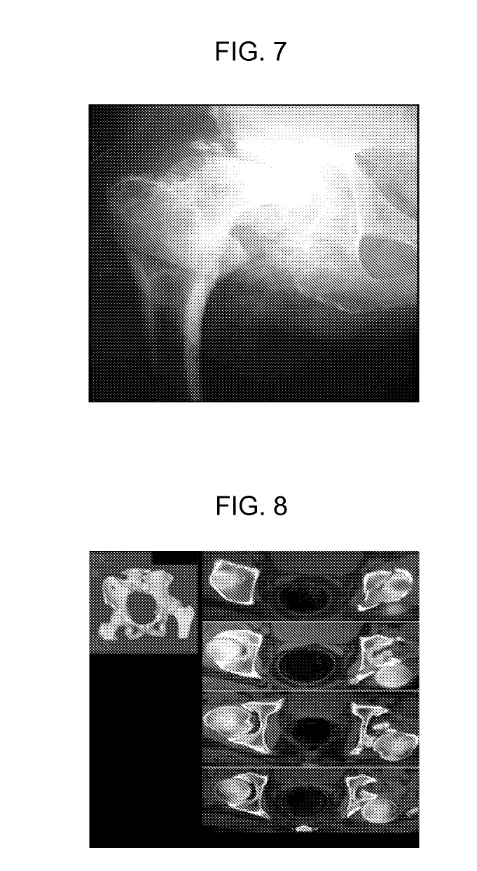

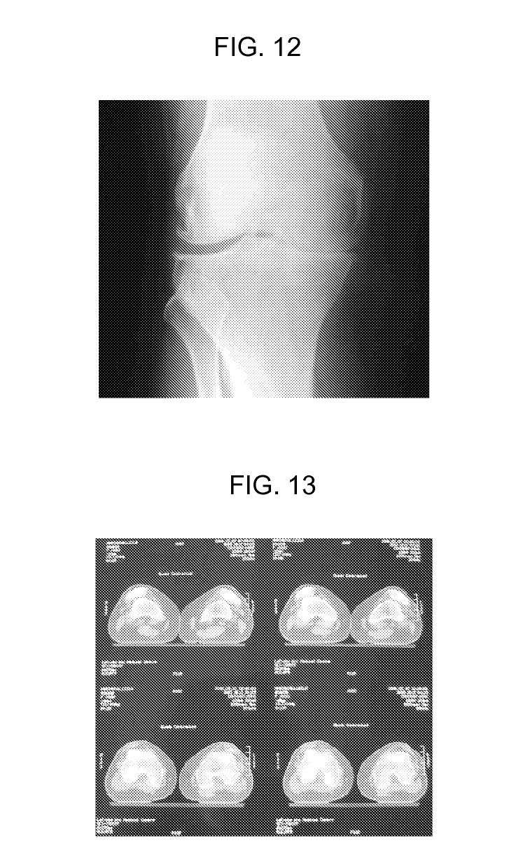

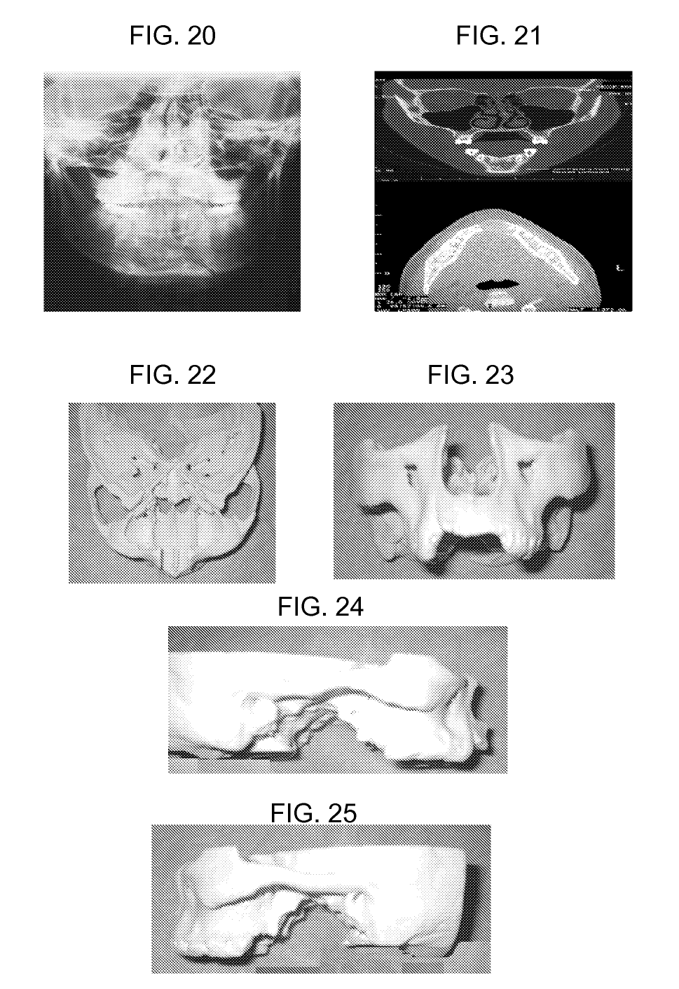

In regards to the above-mentioned figures, we can observe images of some x-ray films of body parts of a living patient, FIG. 1 shows a conventional x-ray film of the thorax, FIG. 7 shows a conventional x-ray film of the hips, FIG. 12 shows a conventional x-ray film of the left knee, FIG. 20 shows a simple front view of the maxillary and the mandible. All these images are obtained in a single incidence or vertical projection in photographic films, over different densities of the rigid tissue which can be delimitated and differentiated from the rest of the tissues by various gray tones.

FIGS. 2, 8, 13 and 21 show a set of conventional tomographies of the thorax, hips, left knee and upper maxillary. These tomographies are photographic printings in various gray tones that discriminate tissue densities which are cuts separated millimetrically (slices).

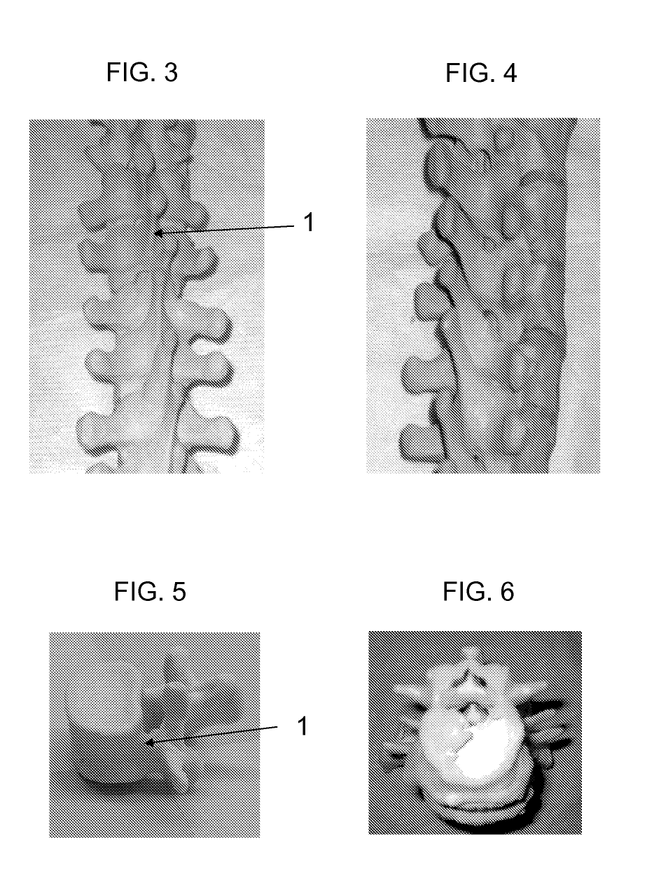

FIGS. 3 and 4 represent tissue of vertebral bodies with their actual size and shape of the lumbar area of a living patient. FIGS. 3 and 5 point out lumbar two (1) of the isolated vertebral body (1) which has specific morphological characters to be observed, FIG. 4 shows another view of said vertebral bodies where the structures can be clearly seen with their actual shape and size, in FIG. 6 we can observe the internal ducts by which the nervous system is lodged.

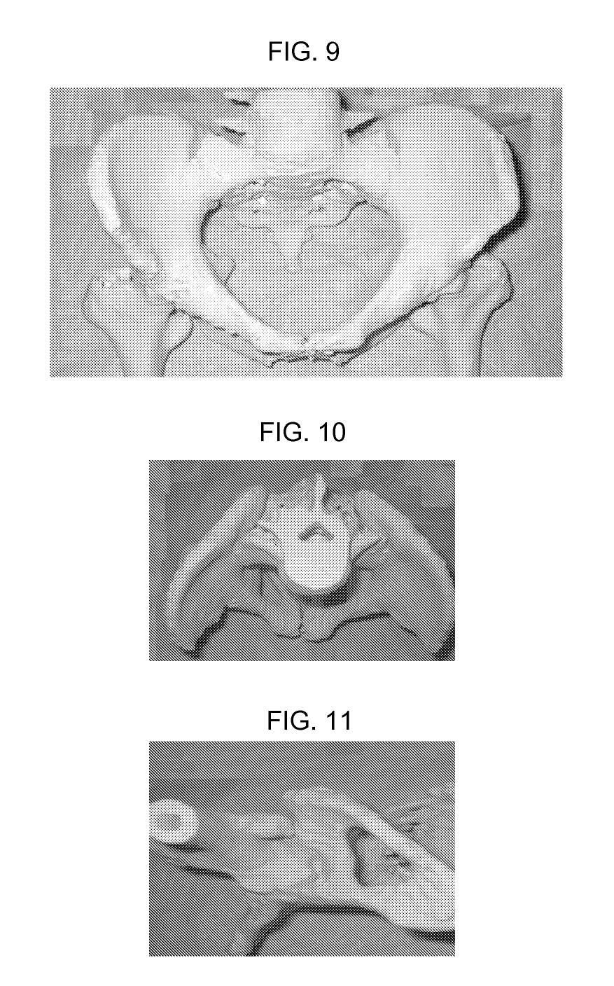

FIGS. 9 and 10 represent tissue of vertebral bodies with their actual size and shape regarding solid models for clinical diagnosis of a living patient, showing also a top view of the hips (FIG. 10) where morphological characters can also be observed in a bottom view (FIG. 11).

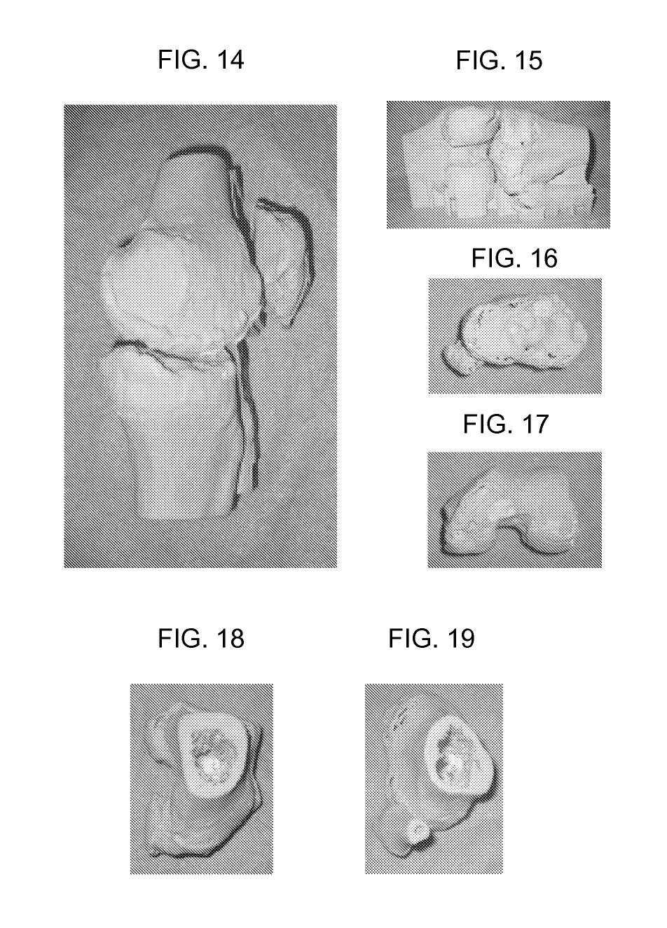

Also, FIGS. 14, 15, 16, 17, 18 and 19 show solid models for clinical diagnosis of the left knee where morphological characters physically represented with their actual size and shape can be observed.

The solid model for clinical diagnosis of the upper maxillary can be observed in FIGS. 22, 23, 24, and 25, as a physical representation with its actual shape and size where its morphological characters are clearly observed.

What is claimed is:

1. An apparatus for creating a solid model for clinical diagnosis comprising:
a tissue scanner that creates digital information;
a processor that processes the digital information;
a computer that generates a virtual model from the digital information; and
a modeler that creates a three-dimensional solid model created from the virtual model.

2. The apparatus of claim 1 wherein the computer comprises a tomographic computer.

3. The apparatus of claim 1 wherein the processor comprises a digital processor.

4. The apparatus of claim 1 wherein the solid model comprises a physical representation of the size, shape and volume of a tissue.

5. The apparatus of claim 1 wherein the solid model comprises information to assess illnesses and diseases that affect the morphology and performance of a tissue.

6. A method for creating solid models for clinical diagnosis comprising the steps of:
distinguishing the internal morphological character of tissues in a living patient by totally isolating it from other tissues for clinical studies;
digitally processing a chosen tissue for clinical assessment by applying advanced engineering techniques;
computing tomography from information obtained from digital processing;
keeping actual existing separation distances between the tissues; and
physically showing the actual size and shape of tissues.

7. The method of claim 6 further comprising accurately distinguishing the internal morphological character of the bones in a living patient.

8. A method for characterizing solid models for clinical diagnosis comprising the steps of:
developing pre-surgery treatments on a non-sterilized field over the solid model with no need of the patient's presence;
measuring accurate and actual dimensions;
evaluating tool needs and special implant designs; and
preparing systems related to the actual surgery.

9. The method of claim 8 wherein the accurate and actual dimensions are used on the solid model to choose the appropriate materials required at any time, including during surgical treatment.

10. The method of claim 8 further comprising planning treatments and surgical operations that provide new surgical techniques for treating, prognosticating, and evaluating progressive injuries on tissues.

11. The method of claim 8 wherein the pre-surgery treatments on a non-sterilized field comprise providing useful information regarding internal characteristics by cutting and dissecting the solid model.

12. The method of claim 8 further comprising saving the solid models indefinitely so the specialist can compare pre- and post-surgical evolutions.

13. The method of claim 8 wherein developing pre-surgery treatments on a non-sterilized field comprise providing the tool to carry out a physical internal view scan of a tissue.

14. The method of claim 8 wherein the pre-surgery treatments comprise:
analyzing actual necessities;
accurately performing surgery;
prioritizing all technical steps; and
greatly reducing surgery time.

15. The method of claim 14 wherein the pre-surgery treatments comprise a comparison tool to evaluate the quality of an actual surgery and the condition of a real tissue.
